(19) United States
(12) Patent Application Publication
(10) Pub. No.: US 2010/0037903 A1
(43) Pub. Date: Feb. 18, 2010

(54) Method for Preparing Flavorful and Aromatic Compounds

(75) Inventors: William Monroe Coleman, III, Winston-Salem, NC (US); Anthony Richard Gerardi, Winston-Salem, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: R. J. Reynolds Tobacco Company

(21) Appl. No.: 12/191,751

(22) Filed: Aug. 14, 2008

(51) Int. Cl. A24B 15/38; B01D 3/40

(52) U.S. Cl. 131/278; 210/664

(57) ABSTRACT

The invention provides a method of preparing a purified, pyrazine-containing aqueous composition by mixing a reducing sugar, a base, and an amino acid in water to produce a mixture; heating the mixture for a time and under conditions conducive to Maillard reactions such that a flavorful and aromatic aqueous solution is formed, the aqueous solution comprising a plurality of pyrazines and a first 4-methylimidazole concentration; distilling the aqueous solution to produce an aqueous distillate comprising a plurality of pyrazines and having a second 4-methylimidazole concentration lower than the first 4-methylimidazole concentration; and collecting the aqueous distillate. The invention also includes flavorful and aromatic aqueous compositions formed by this inventive method, as well as tobacco products (e.g., smokable materials, smoking articles, and smokeless tobacco) incorporating the flavorful and aromatic composition.

### FIELD OF THE INVENTION

The invention relates to compositions useful as additives for tobacco compositions, and in particular, to methods for preparing and purifying flavorful and aromatic compounds.

### BACKGROUND OF THE INVENTION

Popular smoking articles, such as cigarettes, have a substantially cylindrical rod shaped structure and include a charge, roll or column of smokable material such as shredded tobacco (e.g., in cut filler form) surrounded by a paper wrapper thereby forming a so-called “tobacco rod.” Normally, a cigarette has a cylindrical filter element aligned in an end-to-end relationship with the tobacco rod. Typically, a filter element comprises plasticized cellulose acetate tow circumscribed by a paper material known as “plug wrap.” Certain cigarettes incorporate a filter element having multiple segments, and one of those segments can comprise activated charcoal particles. Typically, the filter element is attached to one end of the tobacco rod using a circumscribing wrapping material known as “tipping paper.” It also has become desirable to perforate the tipping material and plug wrap, in order to provide dilution of drawn mainstream smoke with ambient air. A cigarette is employed by a smoker by lighting one end thereof and burning the tobacco rod. The smoker then receives mainstream smoke into his/her mouth by drawing on the opposite end (e.g., the filter end) of the cigarette.

The tobacco used for cigarette manufacture is typically used in blended form. For example, certain popular tobacco blends, commonly referred to as “American blends,” comprise mixtures of flue-cured tobacco, burley tobacco and Oriental tobacco, and in many cases, certain processed tobaccos, such as reconstituted tobacco and processed tobacco stems. The precise amount of each type of tobacco within a tobacco blend used for the manufacture of a particular cigarette brand varies from brand to brand. However, for many tobacco blends, flue-cured tobacco makes up a relatively large proportion of the blend, while Oriental tobacco makes up a relatively small proportion of the blend. See, for example, Tobacco Encyclopedia, Voges (Ed.) p. 44-45 (1984), Browne, The Design of Cigarettes, 3^{rd} Ed., p. 43 (1990) and Tobacco Production, Chemistry and Technology, Davis et al. (Eds.) p. 346 (1999).

Tobacco also may be enjoyed in a so-called “smokeless” form. Particularly popular smokeless tobacco products are employed by inserting some form of processed tobacco or tobacco-containing formulation into the mouth of the user. Various types of smokeless tobacco products are set forth in U.S. Pat. Nos. 1,376,586 to Schwartz; U.S. Pat. No. 3,696,917 to Levi; U.S. Pat. No. 4,513,756 to Pittman et al.; U.S. Pat. No. 4,528,993 to Sensabaugh, Jr. et al.; U.S. Pat. No. 4,624,269 to Story et al.; U.S. Pat. No. 4,987,907 to Townsend; U.S. Pat. No. 5,092,352 to Sprinkle, III et al.; and U.S. Pat. No. 5,387,416 to White et al.; U.S. Pat. App. Pub. No. 2005/0244521 to Strickland et al.; PCT WO 04/095959 to Amarp et al.; PCT WO 05/063060 to Atchley et al.; PCT WO 05/004480 to Engstrom; PCT WO 05/016036 to Bjorkholm; and PCT WO 05/041699 to Quinter et al., each of which is incorporated herein by reference. See also, the types of smokeless tobacco formulations, ingredients, and processing methodologies set forth in U.S. Pat. No. 6,953,040 to Atchley et al.; U.S. Pat. No. 7,032,601 to Atchley et al.; US Pat. Appl. Pub. Nos. 2005/0178398 to Breskin et al. and 2006/0191548 to Strickland et al.; PCT WO 05/041699; and each of which is incorporated herein by reference.

In order to improve the flavor and aroma of tobacco materials used in smoking article or smokeless tobacco manufacture, it is desirable to add flavorful and aromatic compounds, such as pyrazines, aminosugars, and Amadori compounds, to the tobacco material. Various methods for producing such compounds are known in the art. For example, U.S. Pat. No. 6,499,489 to Coleman, III, which is incorporated by reference herein in its entirety, describes a method for generating a flavorful tobacco composition by treating a tobacco suspension with ammonia and heating the treated suspension. The heat treatment produces an environment conducive for Maillard reactions or “browning reactions”. The Maillard reactions are reactions between (i) the amino substituent of amino acids, peptides, proteins or other nitrogen-containing compounds, and (ii) the carbonyl group of a sugar in the reducing form or other carboxyl-containing compounds present in the tobacco composition. Such reactions result in a significant darkening of the tobacco composition, typically to an extremely dark brown color. See e.g., Maillard, Ana. Chim., Vol. 9, pp. 5 and 258 (1916); Hodge, J. Agric. Food Chem., Vol. 1, p. 928 (1953); Nursten, Food Chem., Vol. 6, p. 263 (1981) and Waller et al, ACS Symp. Ser. (1983).

U.S. Pat. No. 6,428,624 to Coleman, III et al. describes a process for producing flavorful and aromatic compounds by heating a mixture comprising a reducing sugar source, a base catalyst, and an amino acid selected from a listed group. The resulting composition is rich in Maillard reaction products such as pyrazines, which are desirable for the aroma and flavor that such compounds can impart to tobacco compositions.

Many other processes for preparing flavorful and aromatic compositions for use in tobacco compositions are set forth in U.S. Pat. No. 3,424,171 to Rooker; U.S. Pat. No. 3,476,118 to Luttich; U.S. Pat. No. 4,150,677 to Osborne, Jr. et al.; U.S. Pat. No. 4,986,286 to Roberts et al.; U.S. Pat. No. 5,074,319 to White et al.; U.S. Pat. No. 5,099,862 to White et al.; U.S. Pat. No. 5,235,992 to Sensabaugh, Jr.; U.S. Pat. No. 6,298,858 to Coleman, III et al.; U.S. Pat. No. 6,325,860 to Coleman, III et al.; U.S. Pat. No. 6,440,223 to Dube et al.; and U.S. Pat. 6,591,841 to White et al.; and US Pat. Appl. Publication No. 2004/0173228 to Coleman, III.

It would be desirable in the art to provide further methods for improving the flavor and aroma of tobacco compositions useful in smoking articles or smokeless tobacco products.

### SUMMARY OF THE INVENTION

The present invention provides a method of producing a purified flavorful and aromatic composition using an aqueous distillation process that provides a distillate rich in pyrazines and having only small amounts of the undesirable byproduct, 4-methylimidazole. Thus, according to the invention, purified aqueous compositions comprising a vast array of pyrazines of wide-ranging structural complexity, including a significant amount of pyrazines having alkyl side chains totaling 4 or more carbon atoms, can be formed. These aqueous compositions are useful as additives for food or tobacco compositions for enhancement of flavor or aroma.

In one aspect, the invention provides a method of purifying a pyrazine-containing aqueous solution comprising: providing an aqueous solution produced through a Maillard reaction, the aqueous solution comprising a plurality of pyrazines and a first 4-methylimidazole concentration; distilling the aqueous solution to produce an aqueous distillate comprising a plurality of pyrazines and a second 4-methylimidazole concentration lower than the first 4-methylimidazole concentration; and collecting the aqueous distillate. The second 4-methylimidazole concentration is typically less than about 20 ppm, and often less than about 10 ppm. The amount of 4-methylimidazole in the aqueous distillate is less than about 5 percent of the 4-methylimidazole in the aqueous solution, and typically less than about 2.5 percent of the 4-methylimidazole in the aqueous solution.

The resulting distillate can be diluted if desired and applied to a tobacco composition, packaging of a tobacco-containing product such as a smoking article, or a component of a smoking article. Exemplary solvents useful for dilution include water, glycerol, propylene glycol, and mixtures thereof. One use for the distillate is as a top dressing or casing for a tobacco material, such as tobacco materials suitable for use in smoking articles or smokeless tobacco compositions.

The manner in which the aqueous solution produced though a Maillard reaction is formed can vary. In one embodiment, the aqueous solution is produced by mixing a reducing sugar, a base, and an amino acid in water to produce a mixture; and heating the mixture for a time and under conditions conducive to Maillard reactions such that a flavorful and aromatic aqueous solution is formed. Exemplary bases include various ammonium compounds such as ammonium hydroxide. Typical examples of reducing sugars include glucose, fructose, lactose, sucrose, rhamnose, xylose, mannose, galactose, and combinations thereof. The amino acid utilized in the reaction can vary, and is preferably selected from those amino acids without sulfur content, such as serine, threonine, valine, leucine, isoleucine, proline, asparagine, and combinations thereof.

The process conditions for the heat treatment can vary. Exemplary heating temperatures include the range of about 25° C. to about 200° C., more often about 80° C. to about 120° C. The heating time period is typically about 30 minutes to about 3 hours.

The invention also provides flavorful and aromatic aqueous compositions prepared according to the inventive method, including compositions comprising at least about 10 mg/mL of a plurality of pyrazines and no more than about 20 ppm of 4-methylimidazole. The C4 pyrazines within certain embodiments of the flavorful and aromatic compositions, which are pyrazines having a total number of carbon atoms as part of alkyl side chains of at least 4, represent at least about 5% of the total pyrazine weight, often at least about 10% of the total pyrazine weight. The composition can also be characterized as having a weight ratio of pyrazine content to 4-MeI content of at least about 500:1, such as about 1,000:1 to about 4,000:1.

In addition, the invention includes tobacco compositions comprising a tobacco material and the inventive flavorful and aromatic aqueous composition, as well as tobacco product comprising such compositions, such as smokable materials, smoking articles, packaging of smoking articles, components of smoking articles, and smokeless tobaccos.

### DETAILED DESCRIPTION OF THE INVENTION

The present invention now will be described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art. As used in this specification and the claims, the singular forms “a,” “an,” and “the” include plural referents unless the context clearly dictates otherwise.

The invention is directed to a method for producing flavorful and aromatic compounds useful as additives for tobacco compositions and, in particular, directed to methods of purifying aqueous compositions in a manner that enriches the concentration of desirable compounds such as pyrazines and reduces the concentration of undesirable compounds such as 4-methylimidazole (hereinafter 4-MeI).

The purification method of the invention can be practiced using any initial aqueous solution that contains flavorful and aromatic compounds generated through Maillard reactions between a nitrogen source (e.g., exogenous amino acids or nitrogen-containing compounds in tobacco materials) and a sugar source (e.g., exogenous reducing sugars or carboxyl-containing compounds in tobacco materials). Typical flavorful and aromatic compounds found in such compositions include a wide variety of pyrazines from simple low molecular weight pyrazines, such as pyrazine and methyl pyrazine, to more complex pyrazines having more alkyl side chains or longer linear or branched alkyl side chains (e.g., 2-isobutyl pyrazine, 2-ethyl-2,5-dimethyl pyrazine, 3-ethyl-2,5-dimethyl pyrazine, tetramethyl pyrazine, 2-isobutyl-3-methyl pyrazine, 2,3,5-trimethyl-6-ethyl pyrazine, 2,6-dimethyl-3-isobutyl pyrazine, and 2,5-dimethyl-3-(2-methylpropyl) pyrazine).

The most preferred compositions of flavorful and aromatic compounds contain a wide array of pyrazines, including a significant amount of pyrazines of greater structural complexity, which are not commercially available and have a greater aroma impact. For example, it is noted that C4 pyrazines (i.e., pyrazines having a total of 4 carbon atoms attached as part of alkyl side chains on the pyrazine ring), such as ethyldimethylpyrazines, have amongst the lowest odor thresholds of any pyrazines. These higher molecular weight pyrazines have an aroma impact of about 250,000 whereas, the C1 analogue, methylpyrazine, has a relative impact of 1. Thus, the higher molecular weight pyrazines are more potent in smaller amounts. Aroma impact scales are discussed, for example, in Ernst T. Theimer, Fragrance Chemistry (1982) Academic Press, New York; and F. A. Fazzalari, editor, Compilation of Odor and Taste Threshold Values Data (1978) ASTM, Philadelphia, which are incorporated herein by reference.

In one embodiment, the method of the invention provides pyrazine compositions comprising at least about 5% by weight, based on the total pyrazine weight, of C4 or higher pyrazines, meaning pyrazines having a total number of carbon atoms as part of alkyl side chains of 4 or more (e.g., two methyl groups and an ethyl group). More typically, the amount of C4 or higher pyrazines will be at least about 8%, or at least about 10%, or at least about 12%. The amount of C3 or higher pyrazines in certain embodiments of the pyrazine-enriched compositions of the invention can be at least about 25% by weight, based on the total weight of the pyrazines, often at least about 30%, and typically at least about 35%.

In one embodiment, the aqueous composition of flavorful and aromatic compounds used in the inventive purification method is produced by mixing a reducing sugar, a base, and an amino acid in water to produce a reaction mixture, and then subjecting the mixture to a heat treatment for a time and under conditions conducive to Maillard reactions. It is preferable for the aqueous composition to remain unfermented throughout the inventive process.

Suitable reducing sugars for use in the mixture include, but are not limited to, glucose, fructose, lactose, sucrose, rhamnose, xylose, mannose, galactose, and combinations thereof. The reducing sugar can be in a pure form or in a crude form, e.g., high fructose corn syrup which contains about 40% or more of fructose. The term “reducing sugar” as used herein also encompasses phosphate-substituted reducing sugars (e.g., glucose-6-phosphate, fructose-6-phosphate, and fructose-1,6-diphosphate) and reducing sugar precursors that can readily release reducing sugars under the reaction conditions employed in Maillard reactions, such as disaccharides, polysaccharides, and derivatives thereof. Alternatively, a combination of a hydroxyketone and an aldehyde can be used as a reducing sugar precursor, as taught in U.S. Pat. No. 6,325,860 to Coleman, III, which is incorporated by reference herein in its entirety. The reducing sugar is typically present in an amount between about 1 to about 50 percent by weight based on the total weight of the reaction mixture, often about 20 to about 45 percent by weight, and most often about 25 to about 40 percent by weight.

The amino acid content of the reaction mixture can vary. As used herein, amino acid refers to organic acids containing both a basic amine group and an acidic carboxyl group. The term encompasses essential and non-essential amino acids and both naturally occurring and synthetic or modified amino acids. The most common amino acids are listed herein by either their full name or by the three letter or single letter abbreviations: Glycine (Gly, G), Alanine (Ala, A), Valine (Val, V), Leucine (Leu, L), Isoleucine (Ile, I), Methionine (Met, M), Proline (Pro, P), Phenylalanine (Phe, F), Tryptophan (Trp, W), Serine (Ser, S), Threonine (Thr, T), Asparagine (Asn, N), Glutamine (Gln, Q), Tyrosine, (Tyr, Y), Cysteine (Cys, C), Lysine (Lys, K), Arginine (Arg, R), Histidine (His, H), Aspartic Acid (Asp, D), and Glutamic acid (Glu, E). In certain embodiments, the reaction mixture includes valine and/or leucine, optionally combined with one or more additional amino acids such as serine, threonine, isoleucine, proline, asparagine, and combinations thereof. Sulfur-containing amino acids are typically avoided as inclusion of such amino acids produces dimethyl disulfide, which negatively impacts flavor and aroma. The amino acid content is preferably derived from exogenous free amino acids, meaning free amino acids added as isolated compounds rather than amino acids complexed in biological materials or extracts of biological materials such as tobacco.

The reaction mixture typically contains from about 0.1% to about 20% of total amino acid content, often from about 0.5% to about 10%, and most often from about 1% to about 5% by weight, based on the total weight of the reaction mixture. It is typical for at least about 50% by weight of the total amino acid content to comprise valine and/or leucine, often at least about 75% or more, and most often at least about 90% or more. The molar ratio of reducing sugar to amino acid in the reaction mixture is typically about 2:1 to about 1:2, often about 1.5:1 to about 1:1.5, and most often about 1:1.

The base can be any base known in the art, such as various nitrogen-containing bases including ammonium compounds. Examples of such ammonium compounds include, but are not limited to, ammonium hydroxide and ammonium salts such as ammonium orthophosphate, ammonium dihydrogen orthophosphate, diammonium monohydrogen orthophosphate, ammonium citrate, ammonium acetate, ammonium carbonate, and the like. The molar ratio between the base and the reducing sugar in the reaction mixture can range from about 0.01:1 to about 2:1, often about 0.1:1 to about 1:1, and most often about 0.4:1 to 0.6:1. In one embodiment, the molar ratio is about 0.5 mole base per mole of reducing sugar.

The aqueous reaction mixture utilized in the method of the invention is formed by mixing a liquid having an aqueous character with the remaining components. The liquid can consist primarily of water, normally greater than about 90 percent water by weight, and can be essentially pure water. For example, the liquid can be distilled or de-ionized water, tap water, or the like. The water mixed with the remaining components to form the aqueous reaction mixture may include minor amounts of various additives known in the art, such as surfactants, organic solvents, or humectants.

Tobacco materials can also be added to the aqueous reaction mixture or can serve as a substitute for the reducing sugar or amino acid components described above. The tobacco material can have the form of processed tobacco parts or pieces (e.g., processed tobacco stems such as cut-rolled or cut-puffed stems, volume expanded tobacco, or reconstituted tobacco manufactured using paper-making type or cast sheet type processes), cured and aged tobacco in essentially natural lamina, cut filler, or stem form, tobacco extract, extracted tobacco pulp, granular or particulate tobacco materials, or a mixture of the foregoing. Exemplary methods for forming flavorful and aromatic compounds using tobacco starting materials are set forth in U.S. Pat. No. 6,298,858 to Coleman, III et al. and U.S. Pat. No. 6,499,489 to Coleman, III, and US Pat. Appl. Publication No. 2004/0173228 to Coleman, III, all of which are incorporated herein by reference in their entirety.

The types of tobaccos used in the reaction mixture of the present invention may vary, and may include flue-cured tobacco, burley tobacco, Oriental tobacco, Maryland tobacco, dark tobacco, dark-fired tobacco, dark air cured (e.g., passanda, cubano, jatin and bezuki tobaccos) or light air cured (e.g., North Wisconsin and galpoa tobaccos), and Rustica tobaccos, as well as other rare or specialty tobaccos. Descriptions of various types of tobaccos, growing practices, harvesting practices and curing practices are set forth in Tobacco Production, Chemistry and Technology, Davis et al. (Eds.) (1999), which is incorporated herein by reference. See, also, the types of tobaccos that are set forth in U.S. Pat. No. 4,660,577 to Sensabaugh, Jr. et al.; U.S. Pat. No. 5,387,416 to White et al.; and U.S. Pat. No. 6,730,832 to Dominguez et al., each of which is incorporated herein by reference. Most preferably, the tobacco materials are those that have been appropriately cured and aged. Especially preferred techniques and conditions for curing flue-cured tobacco are set forth in Nestor et al., Beitrage Tabakforsch. Int., 20 (2003) 467-475 and U.S. Pat. No. 6,895,974 to Peele, which are incorporated herein by reference. Representative techniques and conditions for air curing tobacco are set forth in Roton et al., Beitrage Tabakforsch. Int., 21 (2005) 305-320 and Staaf et al., Beitrage Tabakforsch. Int., 21 (2005) 321-330, which are incorporated herein by reference. Certain types of unusual or rare tobaccos can be sun cured. Manners and methods for improving the smoking quality of Oriental tobaccos are set forth in U.S. Pat. No. 7,025,066 to Lawson et al., which is incorporated herein by reference. Representative Oriental tobaccos include katerini, prelip, komotini, xanthi and yambol tobaccos. Tobacco compositions including dark air cured tobacco are set forth in U.S. application Ser. No. 11/696,416 to Marshall et al., filed Apr. 4, 2007, which is incorporated herein by reference.

Tobacco extracts can be used in solid form (e.g., spray-dried or freeze-dried form), in liquid form, in semi-solid form, or the like. Exemplary tobacco extracts and extraction techniques are set forth, for example, in U.S. Pat. No. 4,150,677 to Osborne, Jr. et al.; U.S. Pat. No. 4,967,771 to Fagg et al.; U.S. Pat. No. 5,005,593 to Fagg et al.; U.S. Pat. No. 5,148,819 to Fagg; and U.S. Pat. No. 5,435,325 to Clapp et al., all of which are incorporated by reference herein. Various tobacco extraction and reconstitution methodologies are set forth in U.S. Pat. No. 5,065,775 to Fagg; U.S. Pat. No. 5,360,022 to Newton; and U.S. Pat. No. 5,131,414 to Fagg, all of which are incorporated by reference herein. See also, the tobacco extract treatment methodologies set forth in U.S. Pat. No. 5,131,415 to Munoz et al. and U.S. Pat. No. 5,318,050 to Gonzalez-Parra, both of which are incorporated by reference herein.

Suitable known reconstituted tobacco processing techniques, such as paper-making techniques or casting-type processes, can be employed. See, for example, the types of paper-making processes set forth in U.S. Pat. No. 3,398,754 to Tughan; U.S. Pat. No. 3,847,164 to Mattina; U.S. Pat. No. 4,131,117 to Kite; U.S. Pat. No. 4,270,552 to Jenkins; U.S. Pat. No. 4,308,877 to Mattina; U.S. Pat. No. 4,341,228 to Keritsis; U.S. Pat. No. 4,421,126 to Gellatly; U.S. Pat. No. 4,706,692 to Gellatly; U.S. Pat. No. 4,962,774 to Thomasson; U.S. Pat. No. 4,941,484 to Clapp; U.S. Pat. No. 4,987,906 to Young; U.S. Pat. No. 5,056,537 to Brown; U.S. Pat. No. 5,143,097 to Sohn; U.S. Pat. No. 5,159,942 to Brinkley et al.; U.S. Pat. No. 5,325,877 to Young; U.S. Pat. No. 5,445,169 to Brinkley; U.S. Pat. No. 5,501,237 to Young; U.S. Pat. No. 5,533,530 to Young; which are incorporated herein by reference. See, for example, the casting processes set forth in U.S. Pat. No. 3,353,541 to Hind; U.S. Pat. No. 3,399,454 to Hind; U.S. Pat. No. 3,483,874 to Hind; U.S. Pat. No. 3,760,815 to Deszyck; U.S. Pat. No. 4,674,519 to Keritsis; U.S. Pat. No. 4,972,854 to Kiernan; U.S. Pat. No. 5,023,354 to Hickle; U.S. Pat. No. 5,099,864 to Young; U.S. Pat. No. 5,101,839 to Jakob; U.S. Pat. No. 5,203,354 to Hickle; U.S. Pat. No. 5,327,917 to Lekwauwa; U.S. Pat. No. 5,339,838 to Young; U.S. Pat. No. 5,598,866 to Jakob; U.S. Pat. No. 5,715,844 to Young; U.S. Pat. No. 5,724,998 to Gellatly; and U.S. Pat. No. 6,216,706 to Kumar; and EPO 565360; EPO 1055375 and PCT WO 98/01233; which are incorporated herein by reference.

The aqueous reaction mixture can be heated using any heating method or apparatus known in the art. In one embodiment, the aqueous composition is heated in a microwave oven. The aqueous tobacco composition should be heated at a temperature sufficiently high to produce flavorful and aromatic compounds, such as pyridines, pyrazines, Amadori compounds, aminosugars, and, to a lesser extent, sugar thermal degradation products such as substituted furans and diketones. The temperature is typically above about 25° C., often above about 50° C., and most often above 75° C., but is generally below about 150° C., often below about 120° C., and most often below about 110° C. Typical temperature ranges include about 25° C. to about 200° C., more often about 80° C. to about 120° C., and most often about 90° C. to about 110° C.

The amount of time that the reaction mixture is subjected to the heat treatment can vary. Normally, the time period is sufficient to heat the mixture at the desired temperature for a period of at least about 10 minutes, typically at least about 20 minutes, more often at least about 30 minutes. Normally, the time period is less than about 3 hours, typically less than about 2 hours, and often less than about 1.5 hours. It is highly desirable to employ a reaction vessel equipped with an agitation mechanism such that the mixture experiences a relatively uniform temperature throughout the treatment period. In particular, it is highly desirable for the reaction mixture to be heated uniformly throughout as much as possible at the maximum temperature to which the mixture is subjected.

The heat treatment typically occurs in a pressure-controlled and pressurized environment, although atmospheric pressure in a vented tank can be used without departing from the invention. Such a pressurized environment is provided, for example, by enclosing the aqueous reaction mixture in an air-sealed vessel or chamber. Examples of vessels that provide a pressure-controlled environment include a high pressure autoclave from Berghof/America Inc. of Concord, Calif., and Parr Reactor Model Nos. 4522 and 4552 available from The Parr Instrument Co. and described in U.S. Pat. No. 4,882,128 to Hukvari et al., as well as CEM Corporation Model XP-1500 and HP-500 pressure vessels. Operation of such exemplary vessels will be apparent to the skilled artisan. See, for example, U.S. Pat. No. 6,048,404 to White. Typical pressures experienced by the aqueous reaction mixture during the heating process often range from about 10 psig to about 1,000 psig, normally from about 20 psig to about 500 psig. Preferred pressure vessels are equipped with an external heating source, and can also be equipped with means for agitation, such as an impeller.

Atmospheric air, or ambient atmosphere, is the preferred atmosphere for carrying out the present invention. However, heat treatment of the aqueous composition can also take place under a controlled atmosphere, such as a generally inert atmosphere. Gases such as nitrogen, argon and carbon dioxide can be used. Alternatively, a hydrocarbon gas (e.g., methane, ethane or butane) or a fluorocarbon gas also can provide at least a portion of a controlled atmosphere in certain embodiments, depending on the choice of treatment conditions and desired reaction products.

A purification process is performed on the aqueous reaction product comprising flavorful and aromatic compounds, such as pyrazines, formed using the methods set forth herein. One problem with the Maillard reactions described herein is the formation of byproducts such as 4-MeI, which is associated with undesirable aroma and flavor off-notes. The purification process comprises a distillation step wherein the aqueous reaction product containing the flavorful and aromatic compounds is distilled using conventional distillation equipment, such as a heated flask, a distillation column, a condenser, and a collection vessel for distillate leaving the condenser. Exemplary distillation equipment and techniques are set forth in U.S. Pat. No. 5,932,073 to Land; U.S. Pat. No. 5,368,698 to Field et al.; U.S. Pat. No. 4,917,770 to Asbury et al.; and U.S. Pat. No. 4,304,638 to Smith, all of which are incorporated by reference herein.

Distillation of the aqueous mixture involves boiling of the aqueous mixture followed by collection and condensation of the resulting vapor. The unpurified aqueous reaction product is first heated to boiling temperature (e.g., about 100° C.) and the resulting vapor is condensed at about 100° C. as distillate. Although normally conducted at atmospheric pressure, the distillation can be accomplished at reduced pressure (i.e., under partial vacuum) and, as a result, reduced temperature. If desired, the distillate collected from the initial distillation process can be distilled again, and in fact, the original distillate can be distilled multiple times if desired.

The distillation process typically produces a distillate that is about 20% to about 99% of the volume of the original reaction product mixture subjected to the distillation (i.e., the mother liquor), such as about 30% to about 70% or about 40% to about 60%. In certain embodiments, it is desirable to capture and use only smaller percentages of the mother liquor. For example, the distillate will typically include at least about 20% of the original volume of mother liquor, often at least about 30%, and more often at least about 40%. The distillate will typically include no more than about 80% of the original volume of mother liquor, often no more than about 70%, and more often no more than about 60%. By separating only a certain percentage of the first distillate produced, further reductions in concentration of 4-MeI can be achieved because more 4-MeI volatilizes during later stages of the distillation.

The collected aqueous distillate surprisingly exhibits a greatly reduced concentration of the undesirable byproduct 4-MeI, while still containing a substantial majority of the desirable compounds such as pyrazines. Prior to distillation, the aqueous reaction product often comprises at least about 800 ppm of 4-MeI and sometimes as much as about 900 ppm. However, the aqueous distillate of the inventive method contains no more than about 20 ppm of 4-MeI, typically no more than about 15 ppm, and often no more than about 10 ppm. In certain embodiments, the concentration of 4-MeI in the distillate is no more than about 5 ppm. Thus, the amount of 4-MeI in the aqueous distillate is less than about 5 percent by weight of the 4-MeI in the aqueous reaction product solution, typically less than about 2.5 percent, and often less than about 1 percent.

Although the 4-MeI content of the distillate is very low, the concentration of pyrazines is surprisingly high. The aqueous distillate can be characterized as having a total pyrazine content of at least about 10 mg/mL, typically at least about 12 mg/mL, and often at least about 15 mg/mL. The weight ratio of pyrazine content to 4-MeI content in the distillate is typically at least about 500:1, often at least about 1,000:1, and more often at least about 3,000:1. Typical ranges for the weight ratio are about 500:1 to about 4,000:1, often about 750:1 to about 3,500:1, and most often about 1,000:1 to about 3,000:1.

Since 4-MeI has a boiling point (190° C.) that is approximately the same as certain relatively high molecular weight pyrazines, such as tetramethyl pyrazine, it is surprising to discover that distillation of the aqueous reaction product results in such a profound drop in 4-MeI concentration while still providing a substantial amount of desirable pyrazine compounds, including significant amounts of higher molecular weight pyrazines. Although not bound by any particular theory of operation, one explanation for the difference in the ability of 4-MeI to enter the distillate, as compared to certain high molecular weight pyrazines with similarly low vapor pressures, is a difference in steam volatility.

When subjected to an aroma panel, certain embodiments of the pyrazine-enriched aqueous distillates produced by the process of the invention are characterized as exhibiting chocolate, roasted, and sweet aromas. When smoking articles incorporating the flavorful and aromatic distillates are smoked, the distillates can be expected to exhibit an aroma that can be characterized as pleasant, clean, sweet, floral, woody, musk-like, and/or fruity.

The aqueous pyrazine-enriched distillate produced in the method of the invention can be further modified as desired prior to use, such as by dilution with a solvent or by addition of further components. As noted above, the pyrazine-enriched compositions of the invention can include significant amounts of complex, higher molecular weight pyrazines that have much greater aroma potency than lower molecular weight pyrazines and, thus, would benefit from a greater level of dilution before use. Exemplary solvents for dilution include water and various alcohols, including glycerol and propylene glycol.

Optional additives include casing materials (e.g., sugars, humectants such as glycerol, cocoa and licorice) and top dressing materials (e.g., flavoring materials such as menthol). The selection of particular casing and top dressing components is dependent upon factors such as the sensory characteristics that are desired, and the selection of those components will be readily apparent to those skilled in the art of cigarette design and manufacture. See, Gutcho, Tobacco Flavoring Substances and Methods, Noyes Data Corp. (1972) and Leffingwell et al., Tobacco Flavoring for Smoking Products (1972). These optional components can be added to the purified pyrazine-enriched composition following distillation or dilution, or can be added prior to heat treatment of the reaction mixture that produces the Maillard reaction products (i.e., before heat treatment).

The composition resulting from the method of the invention contains flavorful and aromatic compounds useful as additives for tobacco used in the manufacture of smoking articles. For example, the composition of flavorful and aromatic substances prepared in accordance with the present invention can be mixed with casing materials and applied to tobacco as a casing ingredient. As is well known in the art, casing materials are used as additives to enhance the flavors in smokable materials. In cigarette manufacturing processes, casing materials are added to tobacco leaf blends before cutting, and are usually applied as suspensions or solutions. The pyrazine-enriched composition can also be incorporated into smoking articles as a top dressing ingredient. As is well known in the art, top dressing is added after the tobacco blend is cut into shreds (i.e., cut filler) to supply aroma or pleasing flavor, and is usually applied as a spray solution. Similarly, the composition of flavorful and aromatic substances can be incorporated into, or applied to reconstituted tobacco materials including cast reconstituted tobacco materials, and reconstituted tobacco materials formed by paper making processes.

Still further, the aqueous distillate also can be incorporated into the cigarette filter, either in the filter plug, plug wrap, or tipping paper. For example, the composition of flavorful and aromatic substances can be incorporated into low-density polyethylene which is formed into strands, and then incorporated into cigarette filters as described in U.S. Pat. No. 4,281,671 to Bynre et al. and U.S. Pat. No. 4,826,905 to Green, Jr. et al. In like manner, the pyrazine-enriched composition can also be applied to cigarette wrapping paper, preferably on the inside surface, during the cigarette manufacturing process.

The pyrazine-enriched composition can also be included as a flavoring agent within certain aerosol-generating electronic smoking articles, such as those described in US Pat. Appl. Publication No. 2008/0092912 to Robinson et al., which is incorporated by reference herein in its entirety. The composition produced by the method of the invention can also be used in the devices available through Atlanta Imports Inc., Acworth, Ga., USA., as an electronic cigar having the brand name E-CIG, which can be employed using associated Smoking Cartridges Type C1a, C2a, C3a, C4a, C1b, C2b, C3b and C4b; and as Ruyan Atomizing Electronic Pipe and Ruyan Atomizing Electronic Cigarette from Ruyan SBT Technology and Development Co., Ltd., Beijing, China.

The amount of the treated aqueous tobacco composition employed per smoking article can vary. Typically, for cigarettes having about 0.6 g to about 1 g of smokable material per rod, about 10 to about 10⁵ ppm of the aqueous pyrazine-enriched composition can be used as a top dressing or casing. Generally, the amount of pyrazine-enriched composition applied to a smokable material will be up to about 5 weight percent, based on the total dry weight of the smokable material. Representative tobacco blends, representative cigarette components, and representative cigarettes manufactured therefrom, are set forth in U.S. Pat. No. 4,836,224 to Lawson et al.; U.S. Pat. No. 4,924,888 to Perfetti et al.; U.S. Pat. No. 5,056,537 to Brown et al.; U.S. Pat. No. 5,220,930 to Gentry; and U.S. Pat. No. 5,360,023 to Blakley et al.; U.S. Pat. Application 2002/0000235 to Shafer et al.; and PCT WO 02/37990. Those tobacco materials also can be employed for the manufacture of those types of cigarettes that are described in U.S. Pat. No. 4,793,365 to Sensabaugh; U.S. Pat. No. 4,917,128 to Clearman et al.; U.S. Pat. No. 4,947,974 to Brooks et al.; U.S. Pat. No. 4,961,438 to Korte; U.S. Pat. No. 4,920,990 to Lawrence et al.; U.S. Pat. No. 5,033,483 to Clearman et al.; U.S. Pat. No. 5,074,321 to Gentry et al.; U.S. Pat. No. 5,105,835 to Drewett et al.; U.S. Pat. No. 5,178,167 to Riggs et al.; U.S. Pat. No. 5,183,062 to Clearman et al.; U.S. Pat. No. 5,211,684 to Shannon et al.; U.S. Pat. No. 5,247,949 to Deevi et al.; U.S. Pat. No. 5,551,451 to Riggs et al.; U.S. Pat. No. 5,285,798 to Banerjee et al.; U.S. Pat. No. 5,593,792 to Farrier et al.; U.S. Pat. No. 5,595,577 to Bensalem et al.; U.S. Pat. No. 5,816,263 to Counts et al.; U.S. Pat. No. 5,819,751 to Barnes et al.; U.S. Pat. No. 6,095,153 to Beven et al.; U.S. Pat. No. 6,311,694 to Nichols et al.; and U.S. Pat. No. 6,367,481 to Nichols, et al.; and PCT WO 97/48294 and PCT WO 98/16125. See, also, those types of commercially marketed cigarettes described Chemical and Biological Studies on New Cigarette Prototypes that Heat Instead of Burn Tobacco, R. J. Reynolds Tobacco Company Monograph (1988) and Inhalation Toxicology, 12:5, p. 1-58 (2000).

The composition resulting from the method of the invention is also useful as an additive for tobacco materials used in smokeless tobacco products. Exemplary smokeless tobacco products are set forth in U.S. Pat. No. 1,376,586 to Schwartz; U.S. Pat. No. 3,696,917 to Levi; U.S. Pat. No. 4,513,756 to Pittman et al.; U.S. Pat. No. 4,528,993 to Sensabaugh, Jr. et al.; U.S. Pat. No. 4,624,269 to Story et al.; U.S. Pat. No. 4,987,907 to Townsend; U.S. Pat. No. 5,092,352 to Sprinkle, III et al.; and U.S. Pat. No. 5,387,416 to White et al.; U.S. Pat. App. Pub. No. 2005/0244521 to Strickland et al.; PCT WO 04/095959 to Arnarp et al.; PCT WO 05/063060 to Atchley et al.; PCT WO 05/004480 to Engstrom; PCT WO 05/016036 to Bjorkholm; and PCT WO 05/041699 to Quinter et al., each of which is incorporated herein by reference. See also, the types of smokeless tobacco formulations, ingredients, and processing methodologies set forth in U.S. Pat. No. 6,953,040 to Atchley et al.; U.S. Pat. No. 7,032,601 to Atchley et al.; US Pat. Appl. Pub. Nos. 2005/0178398 to Breskin et al. and 2006/0191548 to Strickland et al.; PCT WO 05/041699; and each of which is incorporated herein by reference.

One type of smokeless tobacco product is referred to as “snuff.” Representative types of moist snuff products, commonly referred to as “snus,” are manufactured in Europe, particularly in Sweden, by or through companies such as Swedish Match AB, Fiedler & Lundgren AB, Gustavus AB, Skandinavisk Tobakskompagni A/S, and Rocker Production AB. Snus products available in the U.S.A. are marketed under the tradenames Camel Snus Frost, Camel Snus Original and Camel Snus Spice by R. J. Reynolds Tobacco Company. Representative smokeless tobacco products also are marketed under the tradenames Oliver Twist by House of Oliver Twist A/S; Copenhagen, Skoal, SkoalDry, Rooster, Red Seal, Husky, and Revel by U.S. Smokeless Tobacco Co.; “taboka” by Philip Morris USA; and Levi Garrett, Peachy, Taylor's Pride, Kodiak, Hawken Wintergreen, Grizzly, Dental, Kentucky King, and Mammoth Cave by Conwood Sales Co., L.P. See also, for example, Bryzgalov et al., IN1800 Life Cycle Assessment, Comparative Life Cycle Assessment of General Loose and Portion Snus (2005). In addition, certain quality standards associated with snus manufacture have been assembled as a so-called GothiaTek standard.

Descriptions of various components of snus types of products and components thereof, as well as packaging structures for snus products, also are set forth in US Pat. App. Pub. No. 2004/0118422 to Lundin et al., which is incorporated herein by reference. See, also, for example, U.S. Pat. No. 4,607,479 to Linden; U.S. Pat. No. 4,631,899 to Nielsen; U.S. Pat. No. 5,346,734 to Wydick et al.; and U.S. Pat. No. 6,162,516 to Derr; U.S. Pat. App. Pub. Nos. 2005/0061339 to Hansson et al.; 2007/0062549 to Holton, Jr. et al.; 2007/0095356 to Winterson et al.; 2007/0186941 to Holton, Jr. et al.; 2008/0029110 to Dube et al.; 2008/0029116 to Robinson et al.; 2008/0029117 to Mua et al.; and 2008/0173317 to Robinson et al.; PCT WO 2007/057789 to Sweeney et al.; and WO 2007/057791 to Neidle et al.; all of which are incorporated herein by reference. See, also, the types of pouches set forth in U.S. Pat. No. 5,167,244 to Kjerstad, which is incorporated herein by reference.

### Experimental

The present invention is more fully illustrated by the following examples, which are set forth to illustrate the present invention and are not to be construed as limiting thereof. In the following examples, pg means micrograms, mg means milligrams, g means grams, L means liters, and mL means milliliters.

In each example, heat treatment is conducted in a microwave oven manufactured by CEM Corporation, Model Mars X, and using a sealed microwave-permeable reaction vessel. The heat treatment in each example is conducted at 100° C. with a sample temperature ramp-up time of 10 minutes, a microwave power of 1200 watts, a microwave frequency of 2450 MHz, and a sample heating time of 60 minutes.

Following the microwave reaction, the reaction vessel in each example is removed and placed in a freezer to cool for 15 minutes to avoid pressure release of volatiles when opening the vessel. The contents of the vessel and a stir bar are placed in a 250 mL round bottom flask affixed to a conventional laboratory distillation apparatus and heating mantle. The aqueous distillate or condensate is collected in a 50 mL round bottom flask attached post-condenser to the distillation apparatus. Approximately 20-25 mLs of this distillate is collected at 100° C. with stirring. The distillate is stored in a scintillation vial in a −4° C. freezer.

The pre-distillation reaction product and distillate are analyzed by headspace Purge and Trap/Gas Chromatography/Mass Selective Detection (P&T/GC/MSD) for pyrazine content using a Hewlett Packard 6890 GC equipped with a 5973 MSD and 6890 AutoSampler. The GC column is a 30 meter, 0.25 mm I.D. HP-1701 column with a 1.00 μm film thickness. For each sample, 100 μL is placed in a 5 mL sparge tube along with 1 mL of an aqueous standard containing 21.3 mg/L cyclohexanone as an internal standard and 900 μL of deionized water. The yield of volatiles was calculated based on the total ion current (TIC) response of cyclohexanone. See Coleman et al., J. Chrom. Sci. 32:323 (1994), which is incorporated by reference herein in its entirety.

Since injecting water onto a GC column can be detrimental, a simple sample preparation is used for the aqueous distillate. For each sample, 1 mL of the distillate is transferred to a scintillation vial and 9 mL of methanol is added to the vial and the vial is shaken, followed by addition of 1 g of sodium sulfate that has been dried in a 200° C. oven for 2 hours.

The following approach was employed for the Gas Chromatography/Selected Ion Monitoring-Mass Spectrometry (GC/SIM-MSD) analysis of 4-MeI. Calibration standards of 4-MeI purchased from Sigma-Aldrich (>99%) are prepared at concentrations of 5, 10, 14, 25 and 100 μg/mL in deionized water. The standards are subjected to the same sample prep as the distillates. The same Hewlett Packard system noted above is used with a 30 meter, 0.25 mm I.D. DBWAXETR column having a 0.25 μm film thickness.

A co-elution occurs when analyzing the aqueous distillate samples for 4-MeI, which makes a quantitative result more difficult. Taking into account differences between the four most abundant ion fragments in the standard curve and the sample curves for several of the distillates produced in the examples set forth below, a conservative estimate of 4-MeI in the distillate product is about 5.8 ppm (μg/mL). Based on previous research, the amount of 4-MeI produced in the examples set forth herein would be about 900 ppm, indicating that less than one weight percent of 4-MeI from the reaction product is transferred to the distillate.

### EXAMPLE 1

To a microwave permeable vessel is added 12.5 g of rhamnose, 25 mL of water, 5 mL NH₄OH, 0.41 g of leucine, and 0.41 g of valine. The vessel contents are dissolved followed by sealing the vessel and placing it in the microwave. The above-noted distillation process is followed and the resulting distillate is evaluated by an aroma panel and described as having a very pleasing aroma with chocolate, roasted, and sweet notes, with a slight ammonia odor.

This reaction product contains a large array of pyrazines with the largest amount of pyrazines having longer linear or branched alkyl side chains (i.e., C4 or larger side chains). Quantitative analysis of the distillate indicates the presence of an array of low and high molecular weight pyrazines at a total concentration of 17.4 mg/mL.

### EXAMPLE 2

This example was identical to Example 1 except the leucine and valine in the reaction mixture are replaced with 0.42 g of methionine and 0.42 g of cysteine. The resulting distillate is evaluated by an aroma panel and described as having a very displeasing aroma with rotten vegetable notes.

The use of sulfur-containing amino acids in this formulation leads to production of relatively high yields of dimethyl disulfide, which may explain the poor sensory perception of the reaction product.

### EXAMPLE 3

This example was identical to Example 1 except the leucine and valine in the reaction mixture are replaced with 0.41 g of asparagine and 0.41 g of threonine. The resulting distillate is evaluated by an aroma panel and described as having a mildly pleasing aroma with roasted and slightly ammonia notes.

This reaction product also contains a large array of pyrazines, but contains lesser amounts of pyrazines with longer linear or branched alkyl side chains as compared to Example 1.

### EXAMPLE 4

This example was identical to Example 1 except the leucine and valine in the reaction mixture are replaced with 0.83 g of proline. The resulting distillate is evaluated by an aroma panel and described as having a mildly pleasing aroma with roasted nut, hay, and green pepper notes.

This reaction product also contains a large array of pyrazines, but contains lesser amounts of pyrazines with longer linear or branched alkyl side chains as compared to Example 1.

### EXAMPLE 5

This example was identical to Example 1 except the amino acid content of the reaction mixture is 0.13 g leucine, 0.13 g valine, 0.13 g methionine, 0.13 g cysteine, 0.13 g asparagine, 0.13 g threonine, and 0.13 g proline. The resulting distillate is evaluated by an aroma panel and described as having a displeasing aroma with roasted nut, rotten vegetable, smoke pad, onion, mushroom, and ash tray notes.

Inclusion of smaller amounts of leucine and valine in the reaction mixture results in lesser amounts of pyrazines with longer linear or branched alkyl side chains as compared to Example 1.

### EXAMPLE 6

This example was identical to Example 1 except the amino acid content of the reaction mixture is 0.21 g leucine, 0.21 g valine, 0.21 g methionine, and 0.21 g cysteine. The resulting distillate is evaluated by an aroma panel and described as having a displeasing aroma with roasted nut and rotten vegetable notes.

The presence of sulfur-containing amino acids in the reaction mixture again results in relatively high yields of dimethyl disulfide and a corresponding drop in sensory characteristics of the product.

### EXAMPLE 7

This example was identical to Example 1 except the amino acid content of the reaction mixture is 0.21 g leucine, 0.21 g valine, 0.21 g asparagine, and 0.21 g threonine. The resulting distillate is evaluated by an aroma panel and described as having a pleasing aroma with roasted, chocolate, and sweet candy notes.

Inclusion of smaller amounts of leucine and valine in the reaction mixture again results in lesser amounts of pyrazines with longer linear or branched alkyl side chains as compared to Example 1.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. A method of purifying a pyrazine-containing aqueous solution, comprising:
providing an aqueous solution produced through a Maillard reaction, the aqueous solution comprising a plurality of pyrazines and a first 4-methylimidazole concentration;
distilling the aqueous solution to produce an aqueous distillate comprising a plurality of pyrazines and a second 4-methylimidazole concentration lower than the first 4-methylimidazole concentration; and
collecting the aqueous distillate.

2. The method of claim 1, wherein the second 4-methylimidazole concentration is less than about 20 ppm.

3. The method of claim 2, wherein the second 4-methylimidazole concentration is less than about 10 ppm.

4. The method of claim 1, wherein the amount of 4-methylimidazole in the aqueous distillate is less than about 5 percent of the 4-methylimidazole in the aqueous solution.

5. The method of claim 4, wherein the amount of 4-methylimidazole in the aqueous distillate is less than about 2.5 percent of the 4-methylimidazole in the aqueous solution.

6. The method of claim 1, further comprising optionally diluting the aqueous distillate with a solvent; and applying the optionally diluted aqueous distillate to a tobacco product selected from the group consisting of smokable materials, smoking articles, packaging of smoking articles, components of smoking articles, and smokeless tobaccos.

7. The method of claim 6, wherein the solvent is selected from the group consisting of water, glycerol, propylene glycol, and mixtures thereof.

8. The method of claim 6, wherein said applying step comprising applying the optionally diluted aqueous distillate to a smokable material as a top dressing or casing.

9. The method of claim 1, wherein the aqueous solution is produced by mixing a reducing sugar, a base, and an amino acid in water to produce a mixture; and heating the mixture for a time and under conditions conducive to Maillard reactions such that a flavorful and aromatic aqueous solution is formed.

10. The method of claim 9, wherein the base is an ammonium compound.

11. The method of claim 10, wherein the ammonium compound is ammonium hydroxide.

12. The method of claim 9, wherein the reducing sugar is selected from the group consisting of glucose, fructose, lactose, sucrose, rhamnose, xylose, mannose, galactose, and combinations thereof.

13. The method of claim 12, wherein the reducing sugar is rhamnose.

14. The method of claim 9, wherein the amino acid is selected from the group consisting of serine, threonine, valine, leucine, isoleucine, proline, asparagine, and combinations thereof.

15. The method of claim 14, wherein the amino acid is leucine, valine, or a combination thereof.

16. The method of claim 9, wherein the heating step comprises heating at a temperature of about 25° C. to about 200° C.

17. The method of claim 16, wherein the heating step comprises heating at a temperature of about 80° C. to about 120° C.

18. The method of claim 9, wherein the aqueous solution is heated for about 30 minutes to about 3 hours.

19. The method of claim 9, wherein the molar ratio of reducing sugar to amino acid is about 2:1 to about 1:2 in the aqueous solution.

20. The method of claim 1, wherein the weight ratio of pyrazine content to 4-MeI content in the aqueous distillate is at least about 500:1.

21. The method of claim 20, wherein the weight ratio of pyrazine content to 4-MeI content in the aqueous distillate is about 1,000:1 to about 4,000:1.

22. A method of preparing a purified, pyrazine-containing aqueous composition, comprising:
mixing a reducing sugar, a base, and an amino acid in water to produce a mixture;
heating the mixture for a time and under conditions conducive to Maillard reactions such that a flavorful and aromatic aqueous solution is formed, the aqueous solution comprising a plurality of pyrazines and a first 4-methylimidazole concentration;
distilling the aqueous solution to produce an aqueous distillate comprising a plurality of pyrazines and having a second 4-methylimidazole concentration lower than the first 4-methylimidazole concentration; and
collecting the aqueous distillate.

23. The method of claim 22, wherein the second 4-methylimidazole concentration is less than about 20 ppm.

24. The method of claim 23, wherein the second 4-methylimidazole concentration is less than about 10 ppm.

25. The method of claim 22, wherein the amount of 4-methylimidazole in the aqueous distillate is less than about 5 percent of the 4-methylimidazole in the aqueous solution.

26. The method of claim 25, wherein the amount of 4-methylimidazole in the aqueous distillate is less than about 2.5 percent of the 4-methylimidazole in the aqueous solution.

27. The method of claim 22, further comprising optionally diluting the aqueous distillate with a solvent; and applying the optionally diluted aqueous distillate to a tobacco product selected from the group consisting of smokable materials, smoking articles, packaging of smoking articles, components of smoking articles, and smokeless tobaccos.

28. The method of claim 27, wherein said applying step comprising applying the optionally diluted aqueous distillate to a smokable material as a top dressing or casing.

29. The method of claim 22, wherein the base is ammonium hydroxide.

30. The method of claim 22, wherein the reducing sugar is selected from the group consisting of glucose, fructose, lactose, sucrose, rhamnose, xylose, mannose, galactose, and combinations thereof.

31. The method of claim 22, wherein the amino acid is selected from the group consisting of serine, threonine, valine, leucine, isoleucine, proline, asparagine, and combinations thereof.

32. The method of claim 22, wherein the heating step comprises heating at a temperature of about 80° C. to about 120° C.

33. The method of claim 22, wherein the weight ratio of pyrazine content to 4-MeI content in the aqueous distillate is at least about 500:1.

34. The method of claim 33, wherein the weight ratio of pyrazine content to 4-MeI content in the aqueous distillate is about 1,000:1 to about 4,000:1.

35. A flavorful and aromatic aqueous composition comprising a plurality of pyrazines and 4-methylimidazole, wherein the concentration of pyrazines is at least about 10 mg/mL and the concentration of 4-methylimidazole is no more than about 20 ppm.

36. The composition of claim 35, wherein the pyrazine concentration is at least about 15 mg/mL.

37. The composition of claim 35, wherein C4 pyrazines, having a total number of carbon atoms as part of alkyl side chains of at least 4, represent at least about 5% of the total pyrazine weight.

38. The composition of claim 37, wherein C4 pyrazines represent at least about 10% of the total pyrazine weight.

39. The composition of claim 35, wherein the weight ratio of pyrazine content to 4-MeI content is at least about 500:1.

40. The composition of claim 35, wherein the weight ratio of pyrazine content to 4-MeI content is about 1,000:1 to about 4,000:1.

41. A tobacco composition comprising a tobacco material and the composition according to claim 35.

42. A tobacco product comprising the tobacco composition according to claim 41, the tobacco product being selected from the group consisting of smokable materials, smoking articles, packaging of smoking articles, components of smoking articles, and smokeless tobaccos.
